(19) United States
(12) Patent Application Publication
(10) Pub. No.: US 2017/0158478 A1
(43) Pub. Date: Jun. 8, 2017

(54) DEVICE, SYSTEM, AND BOTTLING MACHINE FOR INTRODUCING AN ADDITIVE FLUID INTO A CONTAINER

(71) Applicant: NESTEC S.A., Vevey (CH)

(72) Inventors: Andrea Comin, Vittel (FR); Damien Kannengiesser, Golbey (FR)

(21) Appl. No.: 15/371,903

(22) Filed: Dec. 7, 2016

(30) Foreign Application Priority Data
Dec. 7, 2015 (EP) 15198161.0

(51) Int. Cl. B67C 3/20; B67C 3/28; B67C 3/24; B67C 7/00

(52) U.S. Cl. CPC B67C 3/208; B67C 7/0006; B67C 3/28; B67C 3/242; B67C 7/0046; B67C 2007/0066

(57) ABSTRACT

The invention relates to a device for introducing an additive fluid into a container such as a bottle. The device comprises a support disk, a plurality of fluid lines, each comprising a fluid outlet situated on the perimeter of the support disk, a fluid manifold fixed on the support disk configured to feed the fluid lines with additive fluid, and dosing valves, a dosing valve equipping each fluid line. The device further comprises a pairing assembly for pairing the device with a transfer wheel of a bottling machine, configured to synchronise a rotation of the support disk with a rotation of the transfer wheel with which it is paired. The invention also relates to a system comprising such a device and to a bottling machine comprising such a system. The invention also relates to a method for transforming a bottling machine comprising adding a device for introducing an additive fluid into a container.

### PRIORITY CLAIM

This application claims the benefit of and priority to European Patent Application No. 15198161.0 filed on Dec. 7, 2015, the entire disclosure of which is hereby incorporated by reference.

### FIELD OF THE INVENTION

The present invention concerns the technical field of industrial facilities for filling containers such as bottles with a liquid product, and more particularly bottling machines.

In the present document, the invention is described in relation with bottle filling. The term bottle designates any type of bottle of any size, from flacon to large bottles. Although the invention is more particularly described in the present document in relation to bottle filling, it encompasses filling of other containers such as for example cans or cardboard containers.

It relates more particularly to the filling with an additive fluid of a bottle (or another container) filled or to be filled with another liquid material. In the food industry, the additive may typically be an edible flavouring concentrate, and the main liquid material in the bottle may be any liquid beverage product base such as water, soda, lemonade, a soup, and so on.

The invention relates more particularly to industrial machines comprising a rotary filling wheel, also called filling carousel.

### BACKGROUND OF THE INVENTION

A common way to fill bottles or other containers in an industrial facility uses a bottling machine comprising a rotary filling wheel or carousel. The carousel is essentially a rotary wheel or rotor of large diameter comprising holding and filling arrangements on its perimeter.

Bottles are brought to the holding means of the carousel, and then filled while the carousel rotates over a certain rotation angle. The bottling machine comprises at least a first transfer wheel to supply bottles to transfer from a bottle stock to the carousel, and at least a second transfer wheel to transfer filled bottles to a further device comprised in the filling machine or outside the machine. A transfer wheel is a wheel whose sole function is to receive a container from a first apparatus or another transfer wheel and, by revolution about its axis, transfer the container to a second apparatus or another transfer wheel.

The machine may in particular comprise a device for capping the bottle after it is filled. Such a “capper” may be essentially another rotary wheel having holding and capping arrangements on its perimeter.

The preparation of liquid, for example in the food industry, may require incorporating a small quantity of an additive fluid into a bottle, empty or full of a main liquid material. For example, an aroma, which is a liquid having a highly concentrate flavour, may be introduced in a bottle, before or after the bottle is filled with water, to create flavoured water.

The additive may be introduced into the bottle according to two known alternatives. First, an independent micro-dosing machine (“microdoser”) may be added right upstream the bottling machine. The microdoser usually comprises a small filling carousel with filler valves installed on it to introduce the additive into the bottles while they travel through a certain angle of the carousel. In other words, introducing an additive fluid into a bottle is performed like the filling of the bottle in a bottling machine, but using a smaller carousel and dosing valves configured to dose smaller volumes.

However, it is not always possible to add an independent microdoser upstream of a bottling machine. A microdoser takes up space, and available space is limited in industrial environment.

Adding a new machine in a pre-existing installation is often impossible or very difficult. For example, in plastic water bottle production facilities, the bottling machine inlet—where the bottles enter the bottling machine—is generally situated right at the outlet of a blower in which the bottles are formed. Adding a microdoser implies separating the blower and the bottling machine, and placing the microdoser between them, which is often impossible or entails big changes in the whole production line.

Another known solution to introduce a small quantity of liquid into a bottle is the use of a system called “static microdoser”. A static microdoser consists of a fixed device configured to generate a jet of pressurized additive fluid when a bottle mouth passes under a nozzle of the microdoser. The static microdoser may typically be installed over a transfer wheel of the bottling machine. Such a device is typically used for introducing a very small quantity of liquid nitrogen into beverage bottles. However, the quantity of liquid that may be introduced with such a device is very limited, due to the very limited time available for injection defined by the passage of the opening (mouth) of a bottle under the injection nozzle. Use of a static microdoser is thus limited to the introduction of very small quantity of additives into a bottle. It cannot be used, for example, to introduce an aroma for producing flavoured drinkable water.

The invention, aims to provide a device for introducing an additive fluid into a bottle before or after its filling with a main liquid material, requiring no or little additional space around a pre-existing bottling machine, and without the drawbacks and limited use of a static micro do ser.

### SUMMARY OF THE INVENTION

The objective set out above is met with a device for introducing an additive fluid into a container such as a bottle, comprising a support disk, a plurality of fluid lines, each comprising a fluid outlet situated on the perimeter of the support disk, a fluid manifold fixed on the support disk configured to feed the fluid lines with additive fluid, and dosing valves, a dosing valve equipping each fluid line, the device further comprising a pairing assembly for pairing the device with a transfer wheel of a bottling machine, said pairing assembly being configured to synchronise a rotation of the support disk with a rotation of the transfer wheel with which it is paired.

A flow meter may be provided in each fluid line.

In an embodiment, the pairing assembly may comprise mechanical links configured to centre and to rigidly fix the support disk on a transfer wheel of a bottling machine. The pairing assembly may for example comprise a plurality of columns extending in a substantially orthogonal direction of an underside of the support disk.

In another embodiment, the device may comprise a motor configured to rotate the support disk, and the pairing assembly may comprise electronic circuitry configured to acquire data on the rotation of the transfer wheel with which the device is paired, and, based on the acquired data, to control the motor to synchronise the rotation of the support disk with the rotation of the transfer wheel.

In another embodiment, the pairing assembly may comprise:

a synchronisation axis comprising a first pulley and an second pulley,

a third pulley linked to a rotation axis of the transfer wheel,

a fourth pulley linked to a rotation axis of the support disk,

said first, second, third and fourth pulley being toothed, and

synchronous transmission means between the first pulley and third pulley and between the second pulley and fourth pulley.

The transmission means may be toothed belts or drive chains. This could be advantageous as being cheaper than a solution using a specific coder and a brushless motor.

The device may be configured so that each dosing valve may be operated independently, to fill with additive only some containers traveling on a paired transfer wheel.

The invention also relates to a system for introducing an additive fluid into a container comprising a device as previously described and a transfer wheel of a bottling machine with which it is paired, the transfer wheel comprising a plurality of holding sites on its perimeter configured to hold a container, wherein the device for introducing an additive fluid is oriented relatively to the transfer wheel so that its fluid outlets are located over each holding site of the transfer wheel.

The invention also relates to a bottling machine comprising a container inlet, a container outlet, a carousel for filling the containers with a main liquid material, a capper wheel for sealing the filled containers with caps, at least a first transfer wheel between the container inlet and the carousel, at least a second transfer wheel between the carousel and the capper wheel, wherein the bottling machine comprises a system for introducing an additive fluid into a container as previously described.

In such a bottling machine, the dosing valves of the system for introducing an additive fluid into a container may be controlled to introduce additive fluid during a rotation of the transfer wheel of more than 90°.

In an embodiment, the bottling machine may comprise at least a first and a second system as previously described. In such a case, the bottling machine may comprise devices for introducing an additive fluid into a container wherein each dosing valve may be operated independently, to fill with additive only some containers traveling on a paired transfer wheel, and a first system for introducing an additive fluid into a container may be configured to introduce an additive only into some containers of the containers bottled in the bottling machine, and a second system for introducing an additive fluid into a container may configured to introduce another additive into the remaining containers of the containers bottled in the bottling machine.

When at least two devices for introducing an additive fluid equip two consecutive transfer wheels of the machine, the device for introducing an additive fluid of the first system may be oriented relatively to the transfer wheel of the first system and the device for introducing an additive fluid of the second system may be oriented relatively to the transfer wheel of the second system so that each fluid outlet is offset from a central axis of a corresponding holding site, said central axis passing through the centre of an opening of a container held in the holding site, the offset values and directions being adapted so that, when a container passes from the transfer wheel of the first system to the transfer wheel of the second system, a fluid outlet of the first system and a fluid outlet of the second system are both positioned over the opening while the outlet of the first system does not contact the outlet of the second system.

The invention also relates to a method for transforming a bottling machine comprising a filling carousel and at least a transfer wheel, the method comprising providing a device for introducing an additive fluid into a container according to any one of claims 1 to 5 and pairing said device with a transfer wheel of the bottling machine.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic view of a bottling machine according to the prior art.

FIG. 2 is a general view of a device for introducing an additive fluid into a container according to an embodiment of the invention.

FIG. 3 is a schematic view in three dimensions of a bottling machine according to an aspect of the invention, i.e. a machine equipped with the device of FIG. 2.

FIG. 4A is a schematic view in three dimensions of a system according to an embodiment of an aspect of the invention.

FIG. 4B is a schematic view in three dimensions of a system according to another embodiment of an aspect of the invention.

FIG. 4C is a schematic view in three dimensions of a system according to another embodiment of an aspect of the invention.

FIG. 5 is a schematic partial view of a fluid outlet of a system according to an embodiment of an aspect of the invention and its immediate surroundings.

FIG. 6A is a schematic partial top view of a machine according to a particular embodiment of the invention.

FIG. 6B is a schematic partial view of a fluid outlet of a system according to an embodiment the invention and its immediate surroundings when a container is transferred to or from a filling carousel.

FIG. 7 is a schematic partial top view of a machine according to another particular embodiment of the invention.

### DETAILED DESCRIPTION OF THE INVENTION

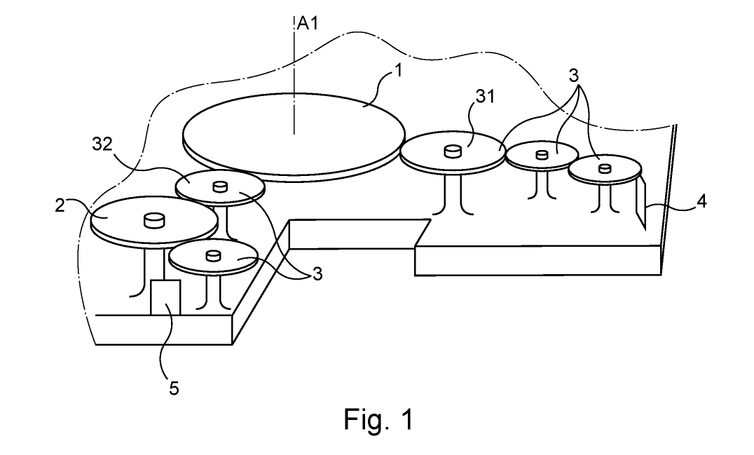

The machine schematically illustrated in FIG. 1 is a bottling machine for bottling containers such as bottles or cardboard containers for example.

More particularly, FIG. 1 represents a bottling machine for plastic bottles (PET bottles—for Polyethylene terephthalate bottles—). The represented bottling machine has a typical design of the machines used for filling plastic bottles with mineral water, soda, or other still or sparkling beverage.

The machine comprises a filling carousel 1 that rotates around a vertical machine axis A1. On the periphery of the carousel, a number of filling positions is formed. At each filling position, the carousel comprises a means for holding a bottle, for example a fork or a gripper for holding a bottle under its opening (bottle mouth). At each filling position, the carousel also comprises a filling head for filling the bottle with a main liquid material.

Each filling head, comprising a discharge opening, is fed with the main liquid material with which the bottles are to be filled via a fluid line comprising a dosing valve. The fluid line is preferably in communication with a manifold feeding the lines of the carousel with the main liquid material being bottled.

The dosing valve of each line may be controlled for example via an actuator device. The valve may be opened for liquid material delivery, or closed to stop the delivery when a bottle is sufficiently filled.

Several solutions may be implemented to determine when the filling must be stopped. The valve of each line may be calibrated to deliver a precise liquid quantity in a predefined time period. A flow meter may be provided in each line for liquid material delivery. A probe may be provided, immersed in the liquid being bottled. When the desired filling volume is reached, a control device closes the dosing valve.

The represented machine also comprises a capping wheel or capper 2, configured to seal the bottles with a cap after they have been filled when held on the carousel.

The represented machine comprises several transfer wheels 3 to transport the bottles to be bottled from a container inlet 4 to the filling carousel 1, from the filling carousel 1 to the capper 2, and from the capper 2 to a container outlet 5.

In particular, the bottles to be filled are each fed to a respective position of the filling carousel 1 by means of an upstream transfer wheel 31. The filled bottles are removed from the filling positions on a downstream transfer wheel 32 and transported to the capper 2, for example.

After a bottle has been transferred from the upstream transfer wheel 31 to a filling position, in a specified angular range of the rotational movement of the rotor 1, the liquid valve is opened to begin this filling phase. The volume to be filled is defined by closing the dosing valve when a specified volume of the liquid being bottled has been dispensed into the bottle provided at the respective filling position.

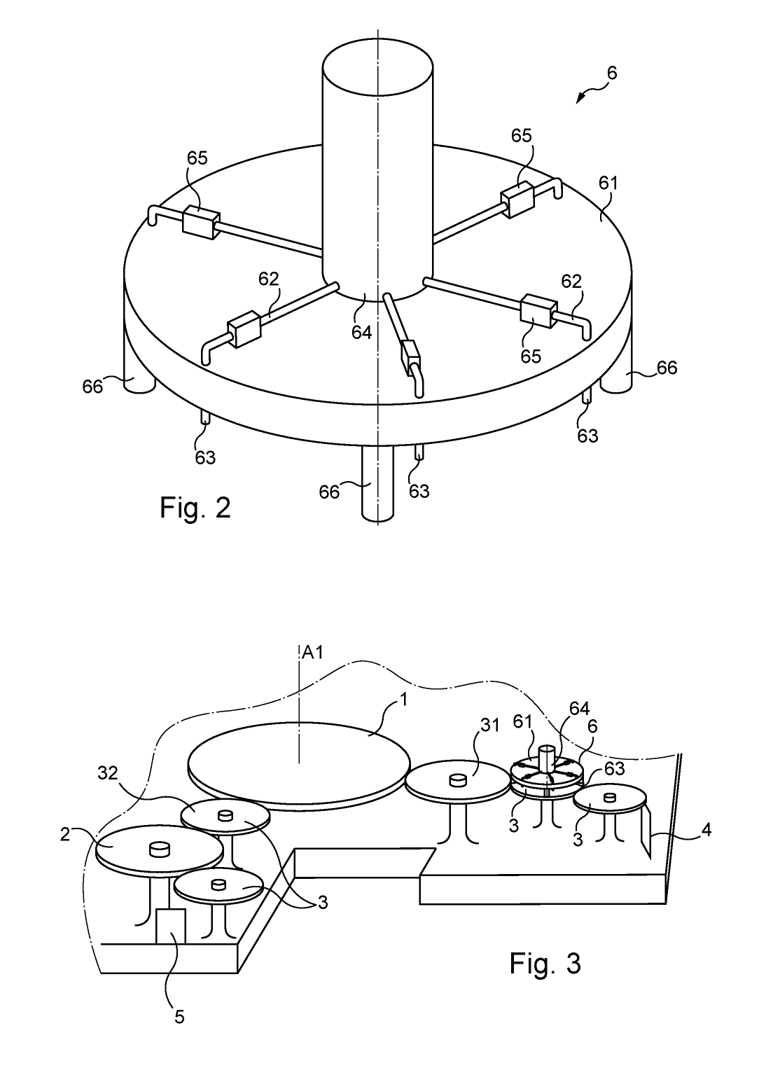

FIG. 2 is a general view of a device for introducing an additive fluid into a container 6 according to an embodiment of the invention.

Additive fluid should be understood as designating a fluid which is correspond to 0.1% to 5%, preferably 0.1% to 1%, of the total fluid content of the bottle or container.

As non-exhaustive examples additive fluid can be a flavour or aroma (for example orange, peach, lemon . . . ), a tea or coffee extract, a fruit juice, a minerals mother solution.

Additionally, the additive fluid can be liquid carbon dioxide or liquid nitrogen according to the required use as know by the skilled person.

The device of FIG. 2 comprises a support disk 61, which is the base piece of the device, on which several components are fastened. The device of FIG. 2 comprises several fluid lines 62. The fluid lines 62 are radially disposed on the support disk 61. Each fluid line 62 ends by a fluid outlet 63. The fluid outlets may be situated on an underside of the support disk 61. At the opposite end of the fluid lines 62, a fluid manifold 64 is provided. The fluid lines 62 are linked to the manifold 64, which may feed them with an additive fluid.

In the represented example embodiment, the fluid lines extend on a top side of the support disk and crosses it to reach the underside next to its periphery. Other configurations are of course possible.

Each fluid line 62 is equipped with a dosing valve 65. The dosing valve may be a calibrated valve configured to deliver a precise predefined quantity of additive fluid in a predefined time.

The device for introducing an additive fluid into a container 6 is configured to be paired with a transfer wheel 3 of a bottling machine. The configuration of the device for introducing an additive fluid into a container 6 relates in particular to the position of the fluid outlets which must match the position of the openings (i.e. mouths) of the bottles held by the transfer wheel. The diameter of the support disk may be more or less the same as the diameter of the transfer wheel on which it is intended to be paired.

Pairing the device for introducing an additive fluid into a container 6 with a transfer wheel requires placing the device for introducing an additive fluid into a container 6 above said transfer wheel, so that the device for introducing an additive fluid into a container 6 is centred relative to the transfer wheel and oriented so that all fluid outlets at a desired position, and to ensure that the device for introducing an additive fluid into a container 6 remain fixed relative to the transfer wheel.

This can be obtained by mechanical means or by precise control of the movement of the device for introducing an additive fluid into a container 6.

In the represented embodiment, columns 66 are provided. The columns 66 are rigidly fixed at one end to the support disk and are configured to be rigidly fixed at the other end to a transfer wheel of a bottling machine.

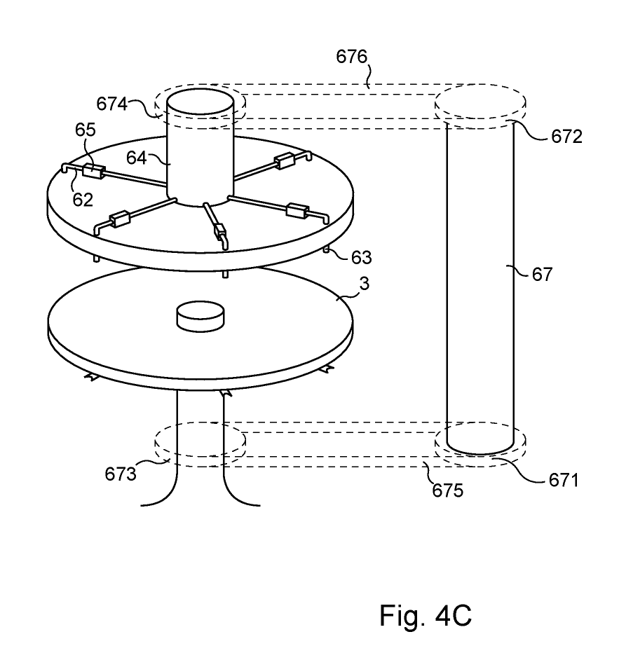

FIG. 4B is a schematic view in three dimensions of a system comprising a device for introducing an additive fluid into a container 6 paired to a transfer wheel 3 of a bottling machine via mechanical means. More particularly, in the represented system, the device for introducing an additive fluid into a container 6 is paired with a transfer wheel 3 of a bottling machine via five columns 66.

In systems using columns to fix the device for introducing an additive fluid into a container 6 to a transfer wheel 3, at least three columns are provided. However, the device for introducing an additive fluid into a container 6 may comprise 4, 5, 6, 8, 10 or more columns.

The columns 66 may for example, as in the represented embodiment of FIG. 4B, comprise or basically consist of threaded rods or studs comprising threaded ends that can be placed in corresponding holes of the transfer wheel. The height of the columns may thus be adjusted to conveniently place the device for introducing an additive fluid into a container 6 above said transfer wheel, typically with the support disk parallel to a top face 33 of the transfer wheel at an adequate distance therefrom.

Other sorts of mechanical link may be used to position and rigidly fix the support disk of the device for introducing an additive fluid into a container 6 on a transfer wheel of a bottling machine. The mechanical fixation of the support disk 61 on the transfer wheel ensures that the device for introducing an additive fluid into a container 6 follows exactly the rotational movement of a transfer wheel with which it is paired. In other words, the rotation of the support disk 61 is synchronised with a rotation of the transfer wheel 3 with which it is paired.

FIG. 4C is a schematic view in three dimensions of a system comprising a device for introducing an additive fluid into a container 6, paired to a transfer wheel 3 of a bottling machine via other mechanical means. In the represented system, the device for introducing an additive fluid into a container 6 is paired with a transfer wheel 3 of a bottling machine via a synchronisation axis 67. The synchronisation axis comprises a first pulley 671 and a second pulley 672. The transfer wheel rotates around a transfer wheel axis comprising a third pulley 673. The support disk 61 rotates around a support disk axis comprising a fourth pulley 674. The synchronisation axis, support disk axis and transfer wheel axis are parallel or substantially parallel. The first pulley 671 is linked to the third pulley 673 and the second pulley is linked to the fourth pulley 674. The pulleys are toothed. To ensure the synchronisation between the transfer wheel 3 and the device for introducing an additive fluid into a container 6, the first and second pulleys have the same number of teeth, and the third and fourth pulleys have the same number of teeth.

Each link between the pulleys is obtained by a synchronous transmission means, such as a toothed belt, a drive chain, or a geared transmission. In the represented embodiment, the synchronisation is obtained via a first toothed belt 675 and a second toothed belt 676.

Instead of mechanical means for pairing the device for introducing an additive fluid into a container 6, the device may be paired to a transfer wheel without been rigidly linked or even physically linked to the transfer wheel, as illustrated in FIG. 4A. In the represented embodiment, rotation means (not shown) such as a motor and driving gears are provided to rotate the device for introducing an additive fluid into a container 6. Synchronisation of the device requires that it be correctly placed above the transfer wheel with which it is paired, and then that the same rotational movement is applied to both the transfer wheel and the device for introducing an additive fluid into a container 6, so that the device remains substantially fixed relative to the transfer wheel 3 with which it is paired. If a shift between the angular position of the device and that of the transfer wheel appears over time, the position of the device may be automatically readjusted.

For example, electronic circuitry (not represented) is configured to acquire data on the rotation of the transfer wheel with which the device is paired, and, based on the acquired data, to control a motor configured to rotate the device in order to synchronise the rotation of the support disk with the rotation of the transfer wheel. Data may be obtained by a position sensor placed on the device or on the transfer wheel, and/or by analysis of the commands sent to the motors rotating respectively the device for introducing an additive fluid into a container 6 and the transfer wheel 3.

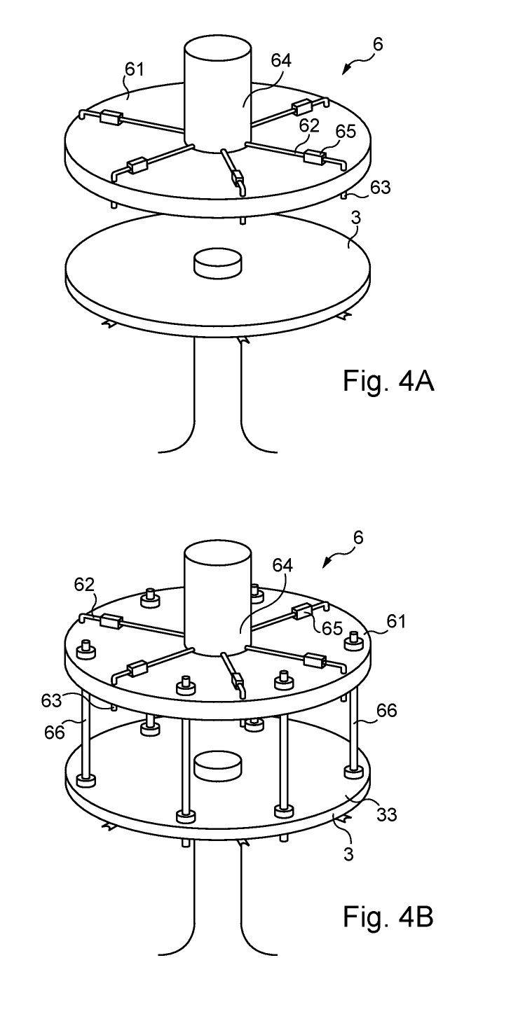

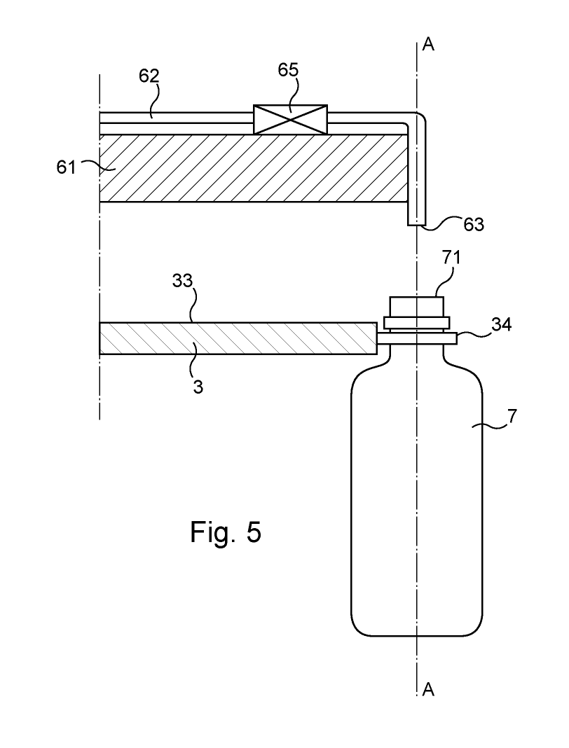

FIG. 3 is a schematic view in three dimensions of a bottling machine according to an aspect of the invention, i.e. a machine equipped with the device of FIG. 2. A device for introducing an additive fluid into a container 7 (such as a bottle) has been installed on a transfer wheel 3. The equipped transfer wheel 3 is situated between the container inlet 4 and the filling wheel. The equipped transfer wheel is in interface with two other transfer wheels. This corresponds to the simplest situation, as the adjacent transfer wheels 3 are free from any equipment that could spatially interfere with the device for introducing the additive. Thus, each fluid outlet of the device may be placed so that, when a bottle is held for example by a grip 34 in a corresponding holding site of the transfer wheel, it is situated on a central axis A of a holding site, said central axis A passing by the centre of an opening 71 of the bottle. Such a configuration is shown in FIG. 5. The additive delivery may be performed during the entire travel time of a bottle on the transfer wheel equipped with the device for introducing an additive fluid into a container 6. This provides much more time for introducing the additive fluid into a container than the time available when a static microdoser is used. More time for introducing the additive fluid makes it possible to introduce more additive fluid, and/or a more precise quantity of additive fluid. Because the rotation speed of the transfer wheel is constant, the travel time of a bottle is proportional to the rotation angle of the transfer wheel between the time a bottle enters a holding site of the transfer wheel and the time it leaves said holding site.

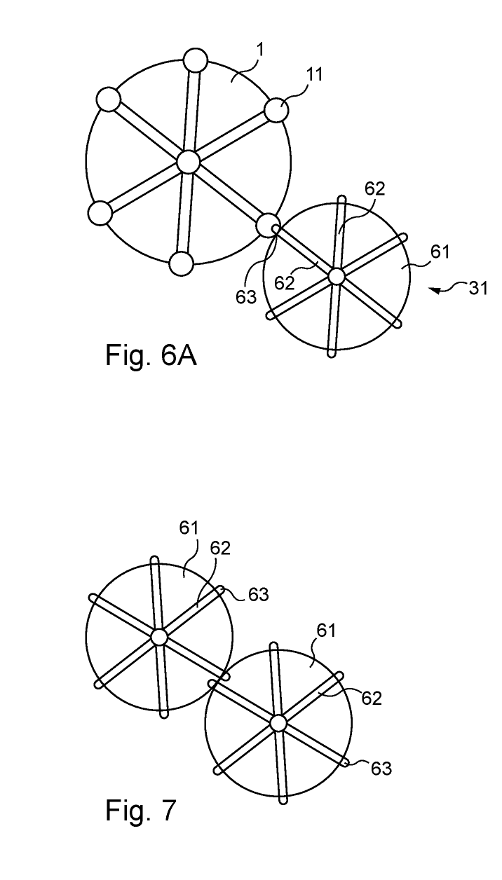

FIG. 6A is a schematic partial top view of a machine according to a particular embodiment of the invention when the transfer wheel equipped with a device for introducing an additive fluid into a container 6 is the upstream transfer wheel 31 or the downstream transfer wheel 32 (which is adjacent to the filling carousel 1).

In the represented embodiment, the upstream transfer wheel 31 is equipped with a device for introducing an additive fluid into a container 6.

In this case, the device installed on the transfer wheel which is adjacent to the filling carousel 1 may mechanically interfere with elements of said filling carousel 1, such as filling head 11 that must be situated over the opening of the container to fill. The critical phase when such mechanical interference or contact may occur is when a container is transferred from the upstream transfer wheel 31 to the carousel 1 or from the carousel 1 to the downstream transfer wheel 32.

In such a case, and as shown in FIG. 6B, the device for introducing an additive fluid 6 may be positioned at a different level compared to the filling heads 11 of the carousel 1, to avoid contact with a filing head 11 when a container 7 is transferred from the transfer wheel 3 to the carousel 1 or form the carousel 1 to the transfer wheel 3. In the configuration shown on FIG. 6B the dosing system is positioned between the neck of the container and the filling head.

The offset may be defined by the angle between the support disk 61 and the paired transfer wheel, compared to a position in which each fluid outlet 63 is aligned with the central axis A of the corresponding holding position of the transfer wheel.

In a similar way, an offset between a device for introducing an additive fluid into a container 6 and the downstream transfer wheel equipped with said device may be provided to avoid mechanical contact or interference of said device (and particularly its fluid outlets) with any equipment of the filling carousel 1, such as a filling head 11.

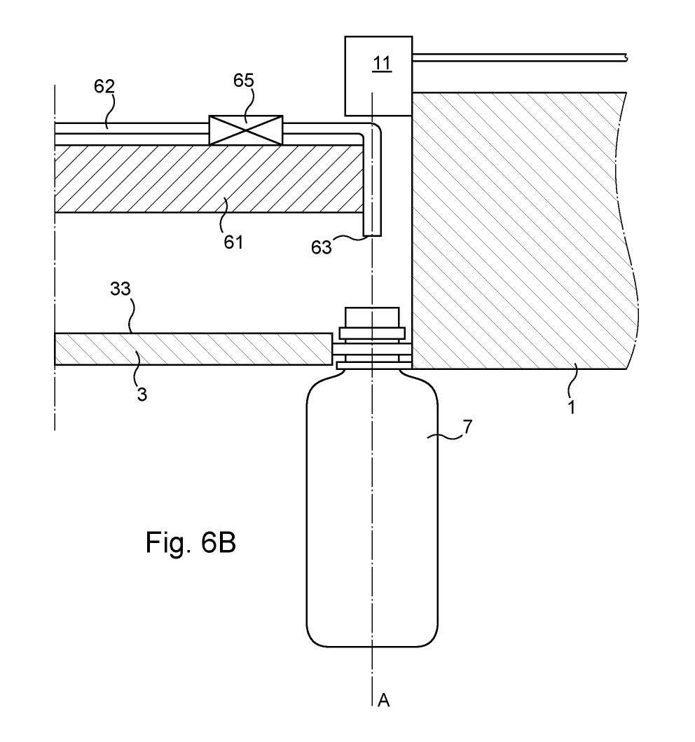

FIG. 7 is a schematic partial top view of a machine according to a particular embodiment of the invention where two devices for introducing an additive fluid into a container 6 equip two adjacent transfer wheels.

Two devices for introducing an additive fluid may be installed on the same bottling machine for the introduction of two different additives, or for the introduction of a greater quantity of the same additive.

Installing two devices for introducing an additive fluid on the same machine makes it possible, by appropriate control of the dosing valves of the two devices, to introduce an additive into certain containers, and another additive into the remaining containers. Different products, for example flavoured waters of different flavour thus may be produced in the same machine, in a predetermined sequence. This makes it for example possible to pack directly in the same package different products output by the same bottling machine.

However, mechanical interference may occur if one of the equipped transfer wheels is adjacent to the filling carousel, as explained in reference to FIG. 6, or when two adjacent transfer wheels are equipped with a device for introducing an additive fluid.

When two adjacent transfer wheels are equipped with a device for introducing an additive fluid, as shown in FIG. 7, the respective fluid outlets of the devices are preferably offset from the central axis A in opposite directions. In some cases, only one fluid outlet of the two devices may be offset. The offset value or values are chosen to avoid any contact or interference between the fluid outlets. If one of the equipped wheels is also adjacent to the filling carousel, the offset value and direction of the device that equips this wheel is chosen so that the fluid outlets of this device also do not interfere or enter into contact with any equipment of the filling carousel.

It should be understood that various changes and modifications to the presently preferred embodiments described herein will be apparent to those skilled in the art. Such changes and modifications can be made without departing from the spirit and scope of the present invention and without losing its attendant advantages. It is therefore intended that such changes and modifications be covered by the appended claims.

For example, the above-described structures can be modified to be used in similar container-handling applications for containers, such as bottles and cans, of various shapes and sizes, and for various types of beverages.

1. A device for introducing an additive fluid into a container wherein the device comprises:
a support disk, a plurality of fluid lines, each comprising a fluid outlet situated on the perimeter of the support disk;
a fluid manifold fixed on the support disk configured to feed the fluid lines with additive fluid, and dosing valves;
a dosing valve equipping each fluid line; and
a pairing assembly for pairing the device with a transfer wheel of a bottling machine, the pairing assembly being configured to synchronise a rotation of the support disk with a rotation of the transfer wheel with which it is paired.

2. The device of claim 1, wherein a flow meter is provided in each fluid line.

3. The device of claim 1, wherein the pairing assembly comprises mechanical links configured to center and to rigidly fix the support disk on a transfer wheel of a bottling machine.

4. The device of claim 3, wherein the pairing assembly comprises a plurality of columns extending in a substantially orthogonal direction of an underside of the support disk.

5. The device of claim 1, wherein the pairing assembly comprises:
a synchronisation axis comprising a first pulley and a second pulley;
a third pulley linked to a rotation axis of the transfer wheel;
a fourth pulley linked to a rotation axis of the support disk;
the first, second, third and fourth pulley being toothed; and
a synchronous transmission member between the first pulley and third pulley and between the second pulley and fourth pulley.

6. The device of claim 5, wherein the transmission members are toothed belts or drive chains.

7. The device of claim 1, wherein the device comprises a motor configured to rotate the support disk, and the pairing assembly comprises electronic circuitry configured to acquire data on the rotation of the transfer wheel with which the device is paired, and, based on the acquired data, to control the motor to synchronise the rotation of the support disk with the rotation of the transfer wheel.

8. The device of claim 1, configured so that each dosing valve may be operated independently, to fill with additive only some containers traveling on a paired transfer wheel.

9. A system for introducing an additive fluid into a container comprising:
a device that comprises: a support disk, a plurality of fluid lines, each comprising a fluid outlet situated on the perimeter of the support disk; a fluid manifold fixed on the support disk configured to feed the fluid lines with additive fluid, and dosing valves; a dosing valve equipping each fluid line; and a pairing assembly for pairing the device with a transfer wheel of a bottling machine, the pairing assembly being configured to synchronise a rotation of the support disk with a rotation of the transfer wheel with which it is paired and a transfer wheel of a bottling machine with which it is paired, the transfer wheel comprising a plurality of holding sites on its perimeter configured to hold a container, wherein the device for introducing an additive fluid is oriented relatively to the transfer wheel so that its fluid outlets are located over each holding site of the transfer wheel.

10. A bottling machine comprising:
a container inlet;
a container outlet;
a carousel for filling the containers with a main liquid material;
a capper wheel for sealing the filled containers with caps;
at least a first transfer wheel between the container inlet and the carousel, at least a second transfer wheel between the carousel and the capper wheel; and
a system for introducing an additive fluid into a container comprising a device that comprises: a support disk, a plurality of fluid lines, each comprising a fluid outlet situated on the perimeter of the support disk; a fluid manifold fixed on the support disk configured to feed the fluid lines with additive fluid, and dosing valves; a dosing valve equipping each fluid line; and a pairing assembly for pairing the device with a transfer wheel of a bottling machine, the pairing assembly being configured to synchronise a rotation of the support disk with a rotation of the transfer wheel with which it is paired and a transfer wheel of a bottling machine with which it is paired, the transfer wheel comprising a plurality of holding sites on its perimeter configured to hold a container, wherein the device for introducing an additive fluid is oriented relatively to the transfer wheel so that its fluid outlets are located over each holding site of the transfer wheel.

11. The bottling machine of claim 10, wherein the dosing valves of the system for introducing an additive fluid into a container are controlled to introduce additive fluid during a rotation of the transfer wheel of more than 90°.

12. The bottling machine of claim 10 comprising a first and second system.

13. The bottling machine of claim 12, wherein the first system is oriented relatively to the transfer wheel of the first system and the device for introducing an additive fluid of the second system is oriented relatively to the transfer wheel of the second system so that each fluid outlet is offset from a central axis of a corresponding holding site, the central axis passing through the center of an opening of a container held in the holding site, the offset values and directions being adapted so that, when a container passes from the transfer wheel of the first system to the transfer wheel of the second system, a fluid outlet of the first system and a fluid outlet of the second system are both positioned over the opening without coming into contact.

14. A method for transforming a bottling machine comprising a filling carousel and at least a transfer wheel, the method comprising providing a device for introducing an additive fluid into a container wherein the device comprises: a support disk, a plurality of fluid lines, each comprising a fluid outlet situated on the perimeter of the support disk; a fluid manifold fixed on the support disk configured to feed the fluid lines with additive fluid, and dosing valves; a dosing valve equipping each fluid line; and a pairing assembly for pairing the device with a transfer wheel of a bottling machine, the pairing assembly being configured to synchronise a rotation of the support disk with a rotation of the transfer wheel with which it is paired and pairing said device with a transfer wheel of the bottling machine.
